(19) United States
(12) Patent Application Publication
(10) Pub. No.: US 2017/0150214 A1
(43) Pub. Date: May 25, 2017

(54) METHOD AND APPARATUS FOR DATA PROCESSING

(71) Applicants: Le Holdings (Beijing) Co., Ltd., Beijing (CN); LeCloud Computing Co., Ltd., Beijing (CN)

(72) Inventor: Zhao DU, Beijing (CN)

(21) Appl. No.: 15/245,329

(22) Filed: Aug. 24, 2016

Related U.S. Application Data
(63) Continuation of application No. PCT/CN2016/082821, filed on May 20, 2016.

(30) Foreign Application Priority Data
Nov. 25, 2015 (CN) 201510830972.8

(51) Int. Cl. H04N 21/442; H04N 21/44; H04N 21/61

(52) U.S. Cl. CPC H04N 21/4424; H04N 21/6156; H04N 21/44

(57) ABSTRACT

The present disclosure provides a method and an apparatus for data processing. The method of the present disclosure mainly includes: determining changed data information of a to-be-sent log corresponding to a full log sent previously, wherein the full log includes all data information; and sending the changed data information of the to-be-sent log to a server. Corresponding with the prior art in which a generated log is directly reported to a server, in the present disclosure, after a full log is sent and before sending a subsequent log, the to-be-sent log is analyzed to find out the changed data information, and only the changed data information instead of fixed data information is sent to the server.

### CROSS-REFERENCE TO RELATED APPLICATIONS

This application is a continuation of International Application No. PCT/CN2016/082821, with an international filing date of May 20, 2016, which is based upon and claims priority to Chinese Patent Application No. 201510830972.8, filed on Nov. 25, 2015, the entire contents of which are incorporated herein by reference.

### TECHNICAL FIELD

The present disclosure generally relates to communication technologies, and particularly, to a method and an apparatus for data processing.

### BACKGROUND

In practical application, a large number of logs may be generated in the process of playing a video by a video player for recording information such as a user's operation behaviors, network status, versions of the video player, types of a terminal system, etc. Users can check a cause of error occurrence or an attack trace left by an attacker by generated logs; if a terminal reports generated logs to a log server, an administrator can make analyses of users' access behaviors on each terminal through the log server.

Specifically, each log generated in the process of playing a video by the video player may carry fixed information such as device types, system types, types or version of the video player or the like, and changed information relative to other logs, for examples, user operations, free memory or video data downloads and other information. In the prior art, the terminal reported all information in each log generated in the process of video playing to the log server, whereas the administrator only needs to check information of one log corresponding to a certain terminal when the administrator makes an analysis of logs through the log server for acquiring its basic information. Therefore, a huge storage space of the log server will be occupied if each terminal reports full logs to the log server for saving, thereby causing waste of resources.

### SUMMARY

The present disclosure provides a method and an apparatus for data processing to solve a problem in the prior art that a huge storage space of a server is occupied because each terminal reports full logs to the server, thereby causing waste of resources.

In a first aspect, embodiments of the present disclosure provide a method for data processing, implemented by a client, including:

determining changed data information of a to-be-sent log corresponding to a full log sent previously, wherein the full log includes all data information; and

sending the changed data information of the to-be-sent log to a server.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for data processing mentioned by embodiments of the present disclosure.

In a third aspect, embodiments of the present disclosure provide a non-transitory computer-readable storage medium storing executable instructions that, when executed by an electronic device, cause the electronic device to perform any methods for data processing mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for data processing in accordance with some embodiments;

FIG. 2 is a flowchart of another method for data processing in accordance with some embodiments;

FIG. 3 is a block diagram showing constitution of an apparatus for data processing in accordance with some embodiments;

FIG. 4 is a block diagram showing constitution of another apparatus for data processing in accordance with some embodiments; and

FIG. 5 is a block diagram showing constitution of an electronic device in accordance with some embodiments.

### DETAILED DESCRIPTION

To make objectives, technical solutions, and advantages of the present disclosure clearer, the embodiments of the present disclosure with reference to the accompanying are described clearly and completely as followed. Apparently, the described embodiments are some but not all of the embodiments of the present disclosure.

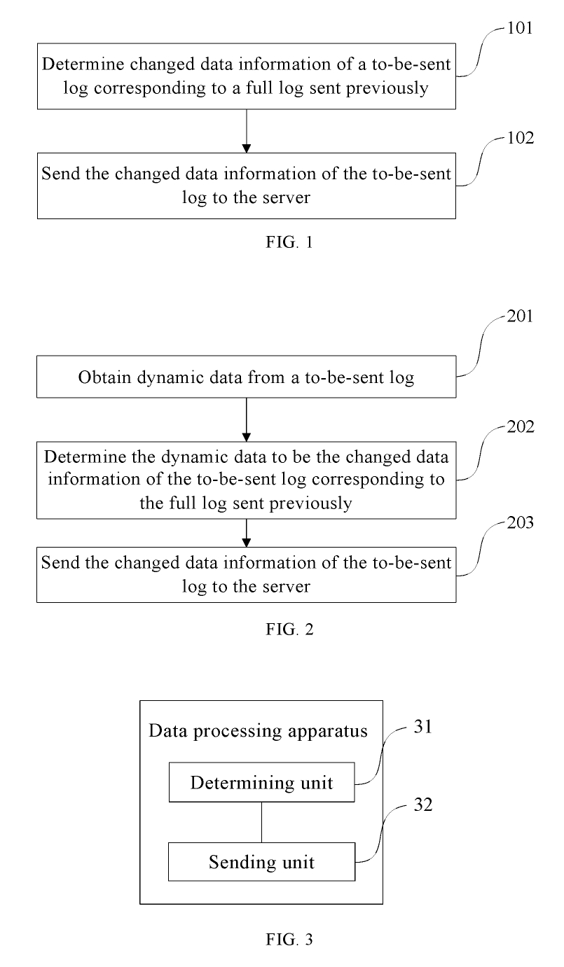

An embodiment of the present disclosure provides a method for data processing, as shown in FIG. 1, the method includes:

101: Determining changed data information of a to-be-sent log corresponding to a full log sent previously.

The logs mentioned in this step are logs generated in the process of playing a video by a video player. In practical application, logs generated when a video is played by a video player can be roughly divided into two types: action logs and heartbeat logs. An action log includes data information related to particular actions such as pause, fast forward and fast backward or the like; and a heartbeat log includes constantly changing data information related to video playing, for example, memory usage of a terminal in the process of video playing, video downloads, etc.

It is to be noted that a full log includes all data information, in other words, a full log is the generated log. In addition, before the to-be-sent log is sent to a server, full logs which are already sent can be one or more, and it is not limited which one or which ones.

102: Sending the changed data information of the to-be-sent log to a server.

The terminal previously has sent a full log containing all data information to the server. Therefore, the administrator may acquire basic information of the terminal used by the user and basic information of the played video by means of analyzing users' behaviors through the full log sent previously. As can be seen, in order to save resources of server, terminals can only send the changed data information of the to-be-sent log corresponding to the full log sent previously instead of fixed data information to the server.

It is to be noted that the server mentioned in the embodiment of the present disclosure can be a log server specially used for storing logs or other type of servers, which is not limited herein.

By using the method for data processing provided by the embodiment of the present disclosure, after a full log is sent to the server, and before sending a subsequent log to the server, the to-be-sent log can be analyzed to find out the changed data information of the to-be-sent log corresponding to the full log sent previously, and only the changed data information instead of the fixed data information of the log is sent to the server. As can be seen, when a terminal sends a generated log to the server instead of complete data information of each log, data volume stored in the server will be reduced and thus resource utilization ratio of the server is increased.

Further, in practical application, each log generated in the process of playing the same video by using the same video player in the terminal contains fixed data information for describing basic information of the video, for example, a video number for identifying the video. Therefore, fixed data information in a log can include fixed data information for describing basic information of the terminal and the video. In order to further reduce data volume of logs stored in the server, when logs generated in the process of playing a certain video are reported to the server, it is possible to report the fixed data information only once (namely, only one full log is reported), and only changed data information of the other logs is reported.

Specifically, in order that the administrator can determine which logs correspond to video A and which logs correspond to video B, a first log generated in the process of playing a certain video can be directly reported, and only changed data information of other subsequent logs corresponding to the video be reported. That is, a specific implementation of the foregoing Step 101 can include determining the changed data information of the to-be-sent log corresponding to an initial log sent previously, where the initial log is a first log generated when a video is played by the video player.

Exemplarily, if the user uses a certain video player to successively play two videos, where 50 logs are generated in the process of playing a first video and 60 logs are generated in the process of playing a second video, contents of the 110 logs sent by the terminal to the server will be: the 1st log of the first video which is a full log, the 2nd log to the 50th log of the first video which are logs only containing changed data information, the 1st log of the second video which is a full log, and the 2nd log to the 60th log of the second video which are logs only containing changed data information.

Further, according to the foregoing embodiment, another embodiment of the present disclosure further provides a method for data processing, as shown in FIG. 2, the method includes:

201: Obtaining dynamic data from the to-be-sent log.

The dynamic data are changed data of a log generated in the process of playing a video, namely, data excluding fixed data information.

In practical application, a specific implementation of obtaining dynamic data from a to-be-sent log can be as below.

A1: Determining static data of the to-be-sent log.

Static data are fixed data of the log generated in the process of playing the video, namely, fixed data for describing basic information of the terminal and a video as mentioned in the foregoing embodiment.

Specifically, in practical application, there are multiple specific implementations of determining the static data of the to-be-sent log, and two of them are taken as examples for a detailed description as following.

Implementation I: The same data of the to-be-sent log and a full log are found out by comparing the to-be-sent log with the full log, and the data found out are determined to be the static data.

Specifically, before sending the to-be-sent log, the terminal has sent at least one full log to the server. Therefore, the terminal can select one full log sent previously as a comparison object, find out the same data of the to-be-sent log and the full log, and determine the data found out to be the static data.

It is to be noted that if original logs (namely, logs generated during playing a video) still remain in the terminal, when the static data of the to-be-sent log are determined, the terminal can also compare the to-be-sent log with a certain log among the original logs, find out the same data in both the logs, and determine the data found out to be the static data.

Implementation II: Data corresponding to preset properties information are looked for from the to-be-sent log, and the data corresponding to the preset properties information found out are determine to be the static data.

The preset properties information includes properties information related to the fixed data, for example, device brands, device models, device memory capacity, device built-in stored capacity, device external extension stored capacity, device operating system, device CPU (Central Processing Unit) models, device CPU frequency, device CPU cores, device screen resolution, video numbers and video channel numbers, etc. During determining the static data of the to-be-sent log, the terminal can scan data information of each property in the log, separately match scanned current property information with each preset properties information, and determine data corresponding to the property information to be the static data if the current property information is successfully matched with certain preset properties information.

A2: Determining data of the to-be-sent log excluding the static data to be the dynamic data.

A3: Obtaining the dynamic data of the to-be-sent log.

It is to be noted that in this step the dynamic data are obtained from the original logs and the original logs are not affected; the original logs can be deleted or reserved if necessary; and the static data in the original logs can be deleted and only the dynamic data therein are reserved if it is required to save storage space of a terminal.

202: Determining the dynamic data to be the changed data information of the to-be-sent log corresponding to the full log sent previously.

The dynamic data are changed data of the log generated in the process of playing the video. Therefore, the dynamic data of the to-be-sent log are changed data corresponding to the full log sent previously and also are changed data corresponding to any log generated in the process of playing the video.

203: Sending the changed data information of the to-be-sent log to the server.

An implementation of this step is the same as that of Step 102 in FIG. 1, and thus is not unnecessarily described herein.

Further, in order to optimize the storage space of the terminal so as to improve resource utilization ratio of the terminal, when the terminal saves logs generated in the process of playing a certain video by the video player, a preset number (for example, only one) of full logs can be saved, and only dynamic data are saved for the other logs. That is, after the changed data information of the to-be-sent log corresponding to the full log sent previously is determined by the terminal, only the changed data information of the to-be-sent log is saved locally, and the fixed data (namely, the static data) of the to-be-sent log are not saved.

Further, according to the foregoing embodiment, another embodiment of the present disclosure further provides an apparatus for data processing, which is used in a terminal, as shown in FIG. 3, the apparatus includes: a determining unit 31 and a sending unit 32.

The determining unit 31 is configured to determine changed data information of a to-be-sent log corresponding to a full log sent previously, where the full log includes all data information; and

the log is a log generated in the process of playing a video by a video player. In practical application, logs generated when a video is played by a video player can be roughly divided into two types: action logs and heartbeat logs. An action log includes data information related to a particular action such as pause, fast forward and fast backward or the like; and a heartbeat log includes constantly changing data information related to video playing, for example, memory usage of a terminal in the process of video playing, video downloads, etc. In addition, before the sending unit 32 sends the to-be-sent log to a server, the full log already be sent can be one or more, and it is not limited which one or which ones.

The sending unit 32 is configured to send the changed data information of the to-be-sent log determined by the determining unit 31 to the server.

It is to be noted that the server mentioned in the embodiment of the present disclosure can be a log server specially used for storing logs or other type of servers, which is not limited herein.

By using the apparatus for data processing provided by the embodiment of the present disclosure, after a full log is sent to the server, and before sending a subsequent log the server, the to-be-sent log is analyzed to find out the changed data information of the to-be-sent log corresponding to the full log sent previously, and only the changed data information instead of the fixed data information of the log is sent to the server. As can be seen, when a terminal sends a generated log to the server instead of complete data information of each log, data volume stored at a server will be reduced and thus resource utilization ratio of the server is increased.

Further, the determining unit 31 is configured to determine the changed data information of the to-be-sent log relative to an initial log sent previously, where the initial log is a first log generated when a video is played by a video player.

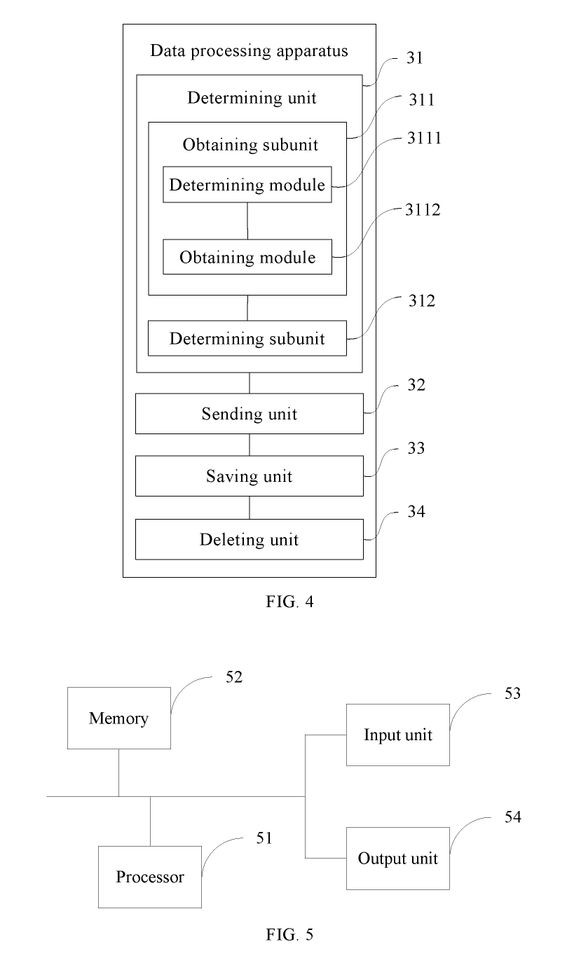

Further, as shown in FIG. 4, the determining unit 31 includes:

an obtaining subunit 311, configured to obtain dynamic data from the to-be-sent log, where the dynamic data are changed data of a log generated in the process of playing a video; and

a determining subunit 312, configured to determine the dynamic data obtained by the obtaining subunit 311 to be the changed data information.

The dynamic data are changed data of the log generated in the process of playing the video. Therefore, the dynamic data of the to-be-sent log are changed data corresponding to the full log sent previously and also are changed data corresponding to any log generated in the process of playing the video.

Further, as shown in FIG. 4, the obtaining unit 311 includes:

a determining module 3111, configured to determine static data of the to-be-sent log, where the static data are fixed data of the log generated in the process of playing the video; and

in practical application, the static data mainly include fixed data information for describing basic information of the terminal and a video.

The determining module 3111 is further configured to determine data of the to-be-sent log excluding the static data to be the dynamic data; and

an obtaining module 3112, configured to obtain the dynamic data of the to-be-sent log determined by the determining module 3111.

It is to be noted that the dynamic data are obtained by the obtaining module 3112 from the original logs and the original logs are not affected; the original logs can be deleted or reserved if necessary; and the static data in the original logs can be deleted and only the dynamic data therein are reserved if it is required to save storage space of a terminal side.

Further, the determining module 3111 is configured to find out the same data in the to-be-sent log and the full log by comparing the to-be-sent log with the full log, and determine the data found out to be the static data.

It is to be noted that if original logs (namely, logs generated during playing a video) still remain in the terminal, when the static data of the to-be-sent log are determined by the determining module 3111, the determining module 3111 can also compare the to-be-sent log with a certain log among the original logs then find out the same data in both logs, and determine the data found out to be the static data.

Further, the determining module 3111 is configured to look for data corresponding to preset properties information from the to-be-sent log, and determine the data corresponding to the preset properties information found out to be the static data.

The preset properties information includes attribute information related to the fixed data, for example, device brands, device models, device memory capacity, device built-in storage capacity, device external extension storage capacity, device operating system, device CPU (Central Processing Unit) models, device CPU frequency, device CPU cores, a device screen resolution, video numbers and video channel numbers, etc. During determining the static data of the to-be-sent log, the determining module 3111 can scan data information of each property in the log, separately match scanned current attribute information with each preset properties information, and determine data corresponding to the property information to be the static data if the current property information is successfully matched with certain preset properties information.

Further, as shown in FIG. 4, the apparatus further includes:

a saving unit 33, configured to save the changed data information of the to-be-sent log; and

a deleting unit 34, configured to delete other data information of the to-be-sent log.

It is to be noted that the saving unit 33 can save the full log previously sent by the sending unit 32. By only saving the full log sent previously and dynamic data of other logs instead of static data of the other logs, the data volume of logs stored in the terminal locally is reduced, and the resource utilization ratio of the terminal is increased.

The apparatus embodiment corresponds to the foregoing method embodiment, and for ease of reading, detailed contents in the foregoing method embodiment are not unnecessarily described one by one in the apparatus embodiment. However, it shall be clear that the apparatus in this embodiment can correspondingly implement all contents in the foregoing method embodiment.

The foregoing apparatus for data processing includes a memory and a processor, the foregoing determining unit, the sending unit, the saving unit and so on; they are stored as program units in the memory executed by the processor to implement corresponding functions.

Further, an embodiment of the present disclosure further provides a non-transitory computer-readable storage medium storing executable instructions, which can be executed by an electronic device to perform any methods for data processing mentioned by embodiments of the present disclosure.

FIG. 5 is a block diagram of an electronic device which is configured to perform the methods for data processing according to an embodiment of the present disclosure. As shown in FIG. 5, the device includes: one or more processors 51 and memory 52. A processor 51 is showed in FIG. 5 for an example.

Device which is configured to perform the methods for data processing can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for data processing mentioned by embodiments of the present disclosure (such as shown in FIG. 3, determining unit 31, sending unit 32). Processor 51 performs kinds of functions and data processing of the electronic device by executing non-transitory software program, instructions and modules which are stored in memory 52, thereby realizes the methods for data processing mentioned by embodiments of the present disclosure.

Memory 52 can include program storage area and data storage area, thereby the operating system and applications required by at least one function can be stored in program storage area and data created by using the device for data processing can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for data processing by networks. The examples of said networks are including but not limited to Internet, Intranet, LAN, mobile Internet and their combinations.

Input unit 53 can be used to receive inputted number, character information and key signals causing user configures and function controls of the device for data processing. Output unit 54 can include a display screen or a display device.

The said module or modules are stored in memory 52 and perform the methods for data processing when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiment set forth above is merely illustrated, where units described as detached parts can be or not be detachable physically; parts displayed as units can be or not be physical units, i.e., either located at the same place, or distributed on a plurality of network units. Modules can be selected in part or in whole according to actual needs for achieving objectives of the solution of the embodiment. It can be known from the foregoing implementation modes, those skilled in the art may clearly know that various implementation modes can be implemented by feat of software and necessary general hardware platform, or of course by means of hardware. On the basis of such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (personal computers, or servers, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for data processing, implemented by a client, comprising:
determining changed data information of a to-be-sent log corresponding to a full log sent previously, wherein the full log comprises all data information; and
sending the changed data information of the to-be-sent log to a server.

2. The method according to claim 1, wherein the determining changed data information of a to-be-sent log corresponding to a full log sent previously comprises:
determining changed data information of the to-be-sent log corresponding to an initial log sent previously, wherein the initial log is the first log generated when a video is played by a video player.

3. The method according to claim 1, wherein the determining changed data information of a to-be-sent log corresponding to a full log sent previously comprises:
obtaining dynamic data from the to-be-sent log, wherein the dynamic data are changed data in a log, which generated in a process of playing a video; and
determining the dynamic data to be the changed data information.

4. The method according to claim 3, wherein the obtaining dynamic data from the to-be-sent log comprises:
determining static data of the to-be-sent log, wherein the static data are fixed data in the log generated in the process of playing the video;
determining data of the to-be-sent log excluding the static data to be the dynamic data; and
obtaining the dynamic data of the to-be-sent log.

5. The method according to claim 4, wherein the determining static data of the to-be-sent log comprises:
finding out the same data between the to-be-sent log and the full log by comparing the to-be-sent log with the full log; and
determining the data found out to be the static data.

6. The method according to claim 4, wherein the determining static data of the to-be-sent log comprises:
searching data corresponding to preset properties information from the to-be-sent log; and
determining the searched data corresponding to the preset properties information to be the static data.

7. The method according to claim 1, wherein the method further comprises:
saving the changed data information of the to-be-sent log, and deleting other data information of the to-be-sent log.

8. An electronic device, comprising:
at least one processor; and
a memory communicably connected with the at least one processor for storing instructions executable by the at least one processor,
wherein execution of the instructions by the at least one processor causes the at least one processor to:
determine changed data information of a to-be-sent log corresponding to a full log sent previously, wherein the full log comprises all data information; and
send the changed data information of the to-be-sent log determined to a server.

9. The electronic device according to claim 8, wherein the instructions are executed to cause the one or more processors to:
determine changed data information of the to-be-sent log corresponding to an initial log sent previously, wherein the initial log is the first log generated when a video is played by a video player.

10. The electronic device according to claim 8, wherein the instructions are executed to cause the one or more processors to:
obtain dynamic data from the to-be-sent log, wherein the dynamic data are changed data in a log, which generated in a process of playing a video; and
determine the obtained dynamic data to be the changed data information.

11. The electronic device according to claim 10, wherein the instructions are executed to cause the one or more processors to:
determine static data of the to-be-sent log, wherein the static data are fixed data in the log generated in the process of playing the video;
determine data of the to-be-sent log excluding the static data to be the dynamic data; and
obtain the dynamic data of the to-be-sent log.

12. The electronic device according to claim 11, wherein the instructions are executed to cause the one or more processors to:
find out the same data between the to-be-sent log and the full log by comparing the to-be-sent log with the full log, and
determine the data found out to be the static data.

13. The electronic device according to claim 11, wherein the instructions are executed to cause the one or more processors to:
search data corresponding to preset properties information from the to-be-sent log, and
determine the searched data corresponding to the preset properties information to be the static data.

14. The electronic device according to claim 8, wherein the instructions are executed to cause the one or more processors to:
save the change data information of the to-be-sent log; and
delete other data information of the to-be-sent log.

15. A non-transitory computer-readable storage medium storing executable instructions that, when executed by an electronic device, cause the electronic device to:
determine changed data information of a to-be-sent log corresponding to a full log sent previously, wherein the full log comprises all data information; and
send the changed data information of the to-be-sent log determined to a server.

16. The non-transitory computer-readable storage medium according to claim 15, wherein the executable instructions are executed to cause the electronic device to: determine changed data information of the to-be-sent log corresponding to an initial log sent previously, wherein the initial log is the first log generated when a video is played by a video player.

17. The non-transitory computer-readable storage medium according to claim 15, wherein the executable instructions are executed to cause the electronic device to:
obtain dynamic data from the to-be-sent log, wherein the dynamic data are changed data in a log, which generated in a process of playing a video; and
determine the obtained dynamic data to be the changed data information.

18. The non-transitory computer-readable storage medium according to claim 17, wherein the executable instructions are executed to cause the electronic device to:
determine static data of the to-be-sent log, wherein the static data are fixed data in the log generated in the process of playing the video;
determine data of the to-be-sent log excluding the static data to be the dynamic data; and
obtain the dynamic data of the to-be-sent log.

19. The non-transitory computer-readable storage medium according to claim 18, wherein the executable instructions are executed to cause the electronic device to:
find out the same data between the to-be-sent log and the full log by comparing the to-be-sent log with the full log, and
determine the data found out to be the static data.

20. The non-transitory computer-readable storage medium according to claim 15, wherein the executable instructions are executed to cause the electronic device to:
save the change data information of the to-be-sent log; and
delete other data information of the to-be-sent log.
